(19) United States
(12) Patent Application Publication
(10) Pub. No.: US 2004/0041793 A1
(43) Pub. Date: Mar. 4, 2004

(54) Handheld multimeter with computer functions

(75) Inventors: Glenn Redding, Flower Mound, TX (US); George Dunning, Coppell, TX (US); Mark Burnett, Lewisville, TX (US)

Correspondence Address: PILLSBURY WINTHROP, LLP, P.O. BOX 10500, MCLEAN, VA, 22102, US

(73) Assignee: THE STANLEY WORKS, New Britian, CT

(21) Appl. No.: 10/322,575

(22) Filed: Dec. 19, 2002

Related U.S. Application Data
(60) Provisional application No. 60/407,236, filed on Sep. 3, 2002.

(51) Int. Cl. G09G 5/00

(52) U.S. Cl. 345/173

(57) ABSTRACT

A handheld multimeter includes an outer shell, a computer processor housed within the outer shell for processing data, and a pressure-sensitive display screen. The display screen is electrically coupled to the processor to enable the processor to display simulated input elements on the screen and enable the user to input data commands into the processor by contacting the display screen. A data port is coupled to the processor. A conductive probe assembly is structured to generate electrical data. The probe assembly is electrically coupled to the data port to enable communication of the electrical data between the probe assembly and the processor. The processor is configured to process the electrical data received from the probe assembly and display an output value on the display screen that includes at least one of an electrical voltage value, an electrical resistance value, and an electrical current value.

The present application claims priority to U.S. Provisional Application of Glenn Redding et al., Application No. 60/407,236, filed Sep. 3, 2002, the entirety of which is hereby incorporated into the present application by reference.

### FIELD OF THE INVENTION

The present invention relates to handheld multimeters.

### BACKGROUND AND SUMMARY OF THE INVENTION

Handheld computers, such as personal organizers and personal digital assistants (PDAs), have grown in popularity partly due to their small size, easy portability, and their versatile operating systems that provide multiple functions such as a scheduler, an address book, a notepad, and connection to the Internet, for example. However, known handheld computers lack the structure and programming to perform the functions of multimeter. Specifically, known handheld computers are unable to measure and display the values of several different electrical parameters such as current, voltage, and resistance.

Typical handheld multimeters cannot offer the user access to the same applications as a handheld computer due to their limited computing power.

It is one object of the present invention to overcome the deficiencies noted above. In accordance with the principles of the present invention, this objective is achieved by providing a handheld multimeter including an outer shell configured to be received in a user's hand, a computer processor housed within the outer shell for processing data, and a pressure-sensitive display screen facing outwardly from a front side of the outer shell. The pressure-sensitive display screen is electrically coupled to the computer processor to enable the processor to display simulated input elements on the screen and enable the user to input data commands into the computer processor by contacting the pressure-sensitive display screen. A data port is coupled to the computer processor. A conductive probe assembly is structured to generate electrical data. The probe assembly is electrically coupled to the data port to enable communication of the electrical data between the probe assembly and the computer processor. The computer processor is configured to (a) process the electrical data received from the probe assembly and display an output value on the display screen that includes at least one of an electrical voltage value, an electrical resistance value, and an electrical current value, and (b) perform the functions of at least one of a scheduler, an address book, and a notepad.

Further, typical multimeters use a graphical display in conjunction with soft keys to operate the multimeter. To reduce the size of the multimeter and improve portability of the multimeter, it would be advantageous to provide a multimeter with a touchscreen display, such as those utilized in handheld computers (e.g., PDAs).

Another object of the present invention is to provide a multimeter with a touchscreen display. In accordance with the principles of the present invention, this objective is achieved by providing a handheld multimeter including an outer shell configured to be received in a user's hand, a computer processor housed within the outer shell for processing data, and a pressure-sensitive display screen facing outwardly from a front side of the outer shell. The pressure-sensitive display screen is electrically coupled to the computer processor to enable the processor to display simulated input elements on the screen and enable the user to input data commands into the computer processor by contacting the pressure-sensitive display screen. A data port is coupled to the computer processor. A conductive probe assembly is structured to generate electrical data. The probe assembly is electrically coupled to the data port to enable communication of the electrical data between the probe assembly and the computer processor. The computer processor is configured to process the electrical data received from the probe assembly and display an output value on the display screen that includes at least one of an electrical voltage value, an electrical resistance value, and an electrical current value.

These and other objects, features, and advantages of this invention will become apparent from the following detailed description when taken into conjunction with the accompanying drawings, which are part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 is top view of an embodiment of a handheld multimeter constructed in accordance with the principles of the present invention;

FIG. 2 is a schematic view of the handheld multimeter of FIG. 1;

FIG. 3 is a perspective view of another embodiment of a handheld multimeter; and

FIG. 4 is a top view of another embodiment of a handheld multimeter.

### DETAILED DESCRIPTION OF ILLUSTRATED EMBODIMENTS

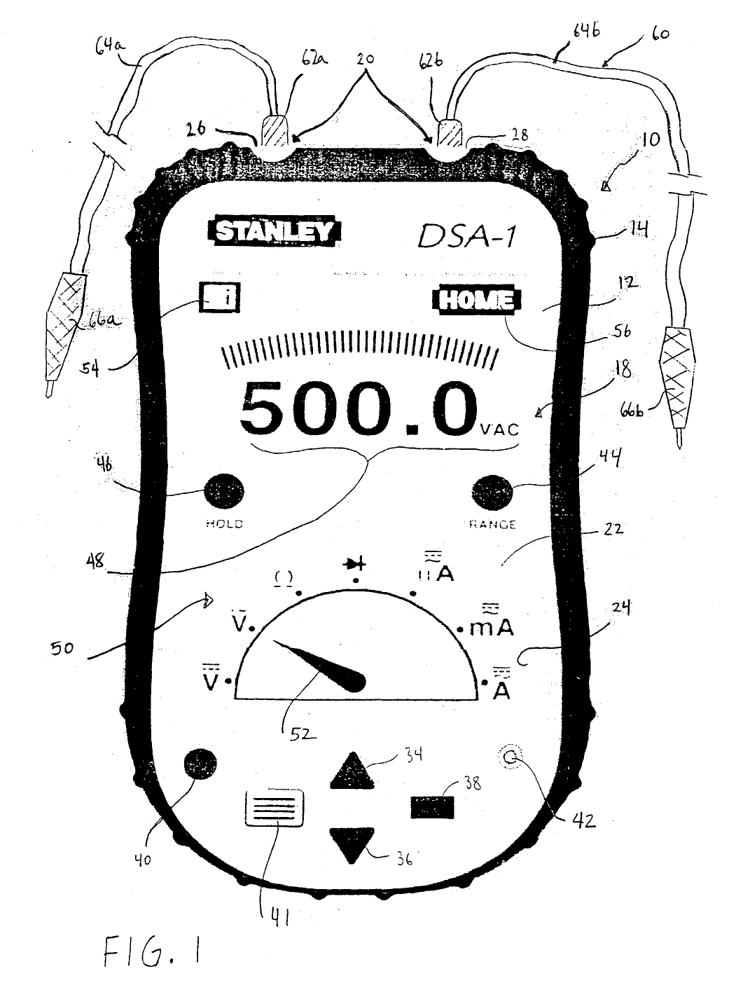

Referring no more particularly to FIG. 1, there is shown therein a handheld multimeter 10, which embodies the principles of the present invention. The handheld multimeter 10 is constructed and arranged to perform several computer functions including performing the function of a multimeter, as will be further discussed. Thus, the handheld multimeter 10 is structured to measure and display the values of several different electrical parameters such as current, voltage, and resistance, for example.

The handheld multimeter 10 includes an outer shell 12, which is preferably made from a hard plastic-based material, such as PVC. As illustrated, the edges 14 of the outer shell 12 are preferably over molded with a higher friction material, such as a high coefficient of friction plastic or a rubber based material, to enhance the grip of the handheld multimeter 10 and provide some impact protection. In the illustrated embodiment, the outer shell 12 has a general rectangular configuration. However, the outer shell may have any configuration, such as being ergonomically designed to comfortably fit any user's hand.

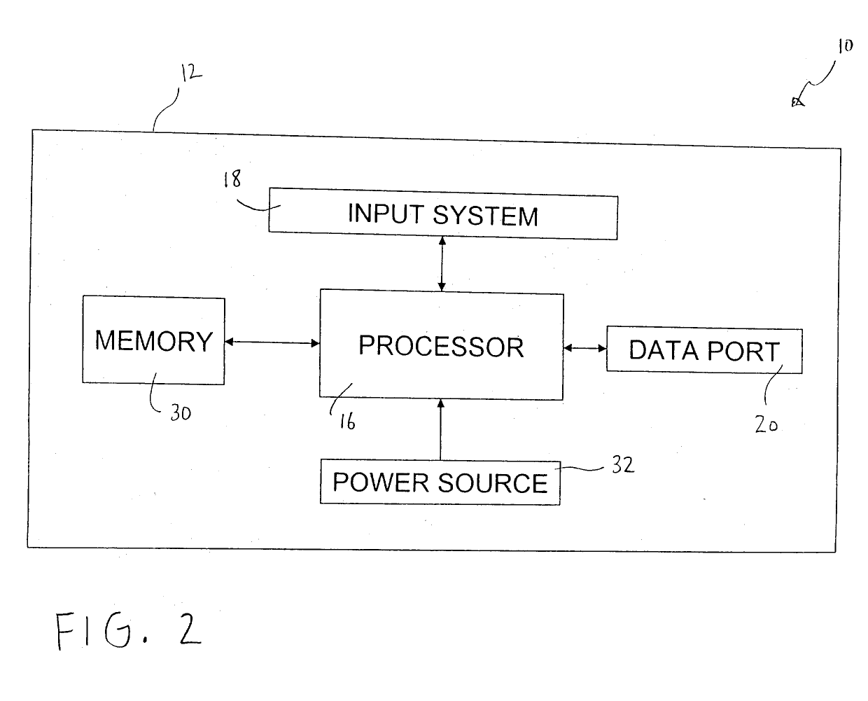

As shown in FIG. 2, a computer processor 16 is housed within the outer shell 12 for protection. The computer processor 16 is adapted to receive data signals from its onboard input/output system 18 and a probe assembly 60 (see FIG. 1) coupled to its data port 20 and to process those data signals. The term processor is used to denote the general processing system for operating the handheld multimeter 10. This processing system may be provided by a single processor responsible for all functions of the multimeter 10 or a series of interconnected processors each dedicated to different functions of the multimeter 10.

The onboard input/output system 18 includes a display screen 22 that is electrically coupled to the computer processor 16 to enable the computer processor 16 to display information on the display screen 22. The display screen 22 is disposed on the front side of the outer shell 12 so as to face outwardly therefrom through an opening 24 in the outer shell 12.

In the illustrated embodiment, the display screen 22 is an LCD screen of the pressure sensitive type (i.e., touchscreen display) that enables the user to input data commands into the computer processor 16 by contacting the display 22 with a contacting member, such as a stylist or finger, to activate a series of pressure sensitive elements embedded within the display 22, as will be further discussed.

The input/output system 18 may also include a plurality of soft keys to supplement the touchscreen display 22. In the illustrated embodiment, the input/output system 18 may include an up-arrow button 34, a down-arrow button 36, and an activation button 38. These buttons may be used to enable the user to input data commands by maneuvering the arrow buttons 34, 36 to maneuver a cursor on the display 22 and activating the activation button 38 to invoke a simulated input element when the cursor is positioned on the input element.

The data port 20 is electrically coupled to the processor 16. The data port 20 is adapted to be electrically coupled to a probe assembly 60 to enable the communication of data between the computer processor 16 and the probe assembly 60. In the illustrated embodiment, the data port 20 includes two input jacks 26, 28 that are structured to be electrically coupled with input ends 62a, 62b of the probe assembly 60. Typically, the probe assembly 60 includes two measuring lines 64a, 64b with each measuring line 64a, 64b including an input end 62a, 62b and a measuring probe 66a, 66b, respectively. As shown in FIG. 1, the input jacks 26, 28 are positioned on an upper edge of the outer shell 12 so the probe assembly 60 does not inhibit visibility of the display 22 when coupled thereto. The probe assembly 60 may be wrapped around the periphery of the outer shell 12 when the handheld multimeter 10 is not in use.

It is contemplated that additional data ports may be provided to enable the processor 16 to be electrically coupled to a keyboard, a personal computer docking cradle, or the Internet, for example. When coupled to a docking cradle, the operating system of the handheld multimeter 10 can be updated, software programs can be added or upgraded, and the user can synchronize data on the handheld multimeter 10 with data on a personal computer, for example.

A memory 30 is electrically coupled to the processor 16 for storing executable programs and data which is to be retrieved at later times. The memory 30 may have any suitable structure, such as ROM and/or volatile/nonvolatile RAM. The memory 30 may be replaced and/or augmented. Further, the memory 30 may be a separate programmed memory module that is coupled to the processor 16.

A multimeter software program is provided for loading into the memory 30 of the handheld multimeter 10 so that the handheld multimeter 10 can perform multimeter functions. The multimeter software program comprises a series of computer executable instructions that are executable by the computer processor 16 to interpret the data signals generated by the probe assembly 60 and convert those signals into instructions which are recognizable and executable by the computer processor 16 and its operating system. For example, the multimeter software program interprets data signals transmitted by the probe assembly 60 and converts them into instructions which the operating system recognizes and causes the processor 16 to execute.

Typical PDA software programs are also loaded into the memory 30 of the handheld multimeter 10 so that the handheld multimeter 10 can perform typical PDA functions such as a scheduler, an address book, and a notepad.

A power source 32 is coupled to the processor 16 to supply power for operating the processor 16. The power source 32 may be battery power, DC power, or any other suitable power source.

A power button 40 is mounted on a lower portion of the outer shell 12 adjacent the softkey input system. The power button 40 is coupled to the power source 32 to turn the handheld multimeter 10 on and off. An LED 42 is provided to generate a light when the power button 40 is in the on position. The power source 32 may be in the form of an auto-power off power source wherein the power source 32 automatically powers off when not in use after a predetermined period of time, i.e., 30 minutes.

A speaker/buzzer 41 is coupled to the processor 16 to provide audio confirmation when performing a continuity check with the multimeter function and/or to provide an alarm to notify the user of an appointment with the calendar function, for example. The speaker/buzzer 41 may also act as a voice recorder to record notes.

The multimeter 10 may include a backlight to illuminate the display 22 for clearer readings in poorly lighted areas. The display 22 may include a backlight key for operating the backlight feature.

Operation of the handheld multimeter 10 will now be described in greater detail. The multimeter software program within the memory 30 includes the series of computer executable instructions that are executable by the computer processor 16 to display simulated input elements on the display 22. As shown in FIG. 1, the input elements include a plurality of keys corresponding to conventional symbols associated with multimeters such as a range key 44 and a hold key 46 for maintaining an element on the display 22. The display 22 displays a digital output value 48 with the unit of measurement (e.g., 500 VAC) measured by the probe assembly 60 coupled to the handheld multimeter 10. The graphical user interface display 22 also includes a graphical display 50 that corresponds to operating ranges of the multimeter function of the handheld multimeter 10. Specifically, the graphical display 50 includes an indicator 52 that indicates the electrical parameter that the user is measuring. The indicator 52 is adjustable such that the multimeter can read and measure AC voltage, DC voltage, resistance, and various magnitudes of current, for example. The indicator 52 is also adjustable such that the handheld multimeter 10 can perform a continuity check. The user must select which operating range is appropriate for the measurement the user wants to make.

The display 22 includes a information key 54 dedicated to an information function. This key may invoke the processor 16 to display a help guide for operating the multimeter function of the handheld multimeter 10, a products guide, or a teaching guide for non-skilled users whom are diagnosing home repairs, automotive repairs, industrial repairs, etc. on a variety of fix-it-yourself items.

The display 22 also includes a HOME key 56 that can direct the user to a simulated menu that includes input elements for typical PDA functions such as a scheduler, an address book, and a notepad.

The display 22 may include a number of keys dedicated to predetermined macro functions that invoke predetermined commands that are often utilized by the user when operating the handheld multimeter 10.

In operation, the input system 18 (i.e., touchscreen display 22 or softkeys 34, 36, 38) is configured to determine when a user invokes a simulated input element displayed on the display screen 22. For example, the user may contact the appropriate location on the display screen with a stylist or finger so as to activate an input element and the processor as directed by the computer executable instructions determines that element has been invoked by sensing actuation of the pressure sensitive elements at the associated location on the screen. The processor then executes a command or data input corresponding to the invoked simulated input element.

When utilizing the multimeter function of the handheld multimeter 10, the user adjusts the indicator 52 to the desired operating range with the input system 18. Then, the user uses the probe assembly 60 coupled to the data port 20 to perform the desired measurement with the output value being displayed on the display 22.

In some typical PDA functions, such as notepad, the user may contact the display 22 in a handwriting-type manner to activate the pressure sensitive elements within the display 22. A series of computer executable instructions coverts the handwriting type movements into data for processing and/or storage.

The handheld multimeter 10 may include a cover pivotally connected to the outer shell 12 for selective movement about a rotational axis between a protecting position and an operating position. In the protecting position, the cover is positioned in overlying relationship with respect the front side of the handheld multimeter 10 to protect the display 22. The handheld multimeter 10 may include a cover that is slidably mountable to the outer shell 12.

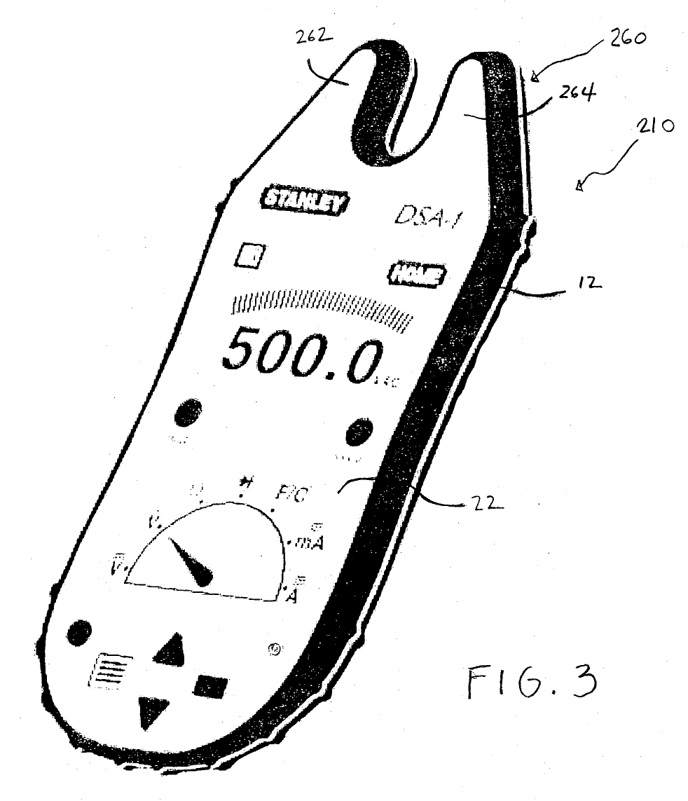

Another embodiment of the handheld multimeter, indicated as 210 is shown in FIG. 3. In this embodiment, the handheld multimeter 210 includes a built-in probe assembly 260 at a top edge thereof. The remaining components of the handheld multimeter 210 are similar to the components of the handheld multimeter 10 and thus will not be further detailed herein. The built-in probe assembly 260 includes a first probe 262 and a second probe 264 that are electrically coupled to the processor 16 to enable the communication of data between the processor 16 and the first and second probes 262, 264. The outer shell 12 is suitably structured to accommodate the first and second probes 262, 264. In operation, the user positions the first and second probes 262, 264 adjacent to or in contact with the component to be measured. The display 22 displays the output value in accordance with the selected measurement.

Alternatively, the first and second probes 262, 264 may be movably mounted within the outer shell 12 to enable the user to extend the first and second probes 262, 264 outwardly from the housing 12 to perform a measurement and to retract the first and second probes 262, 264 back into the outer shell 12 after measurements have been completed.

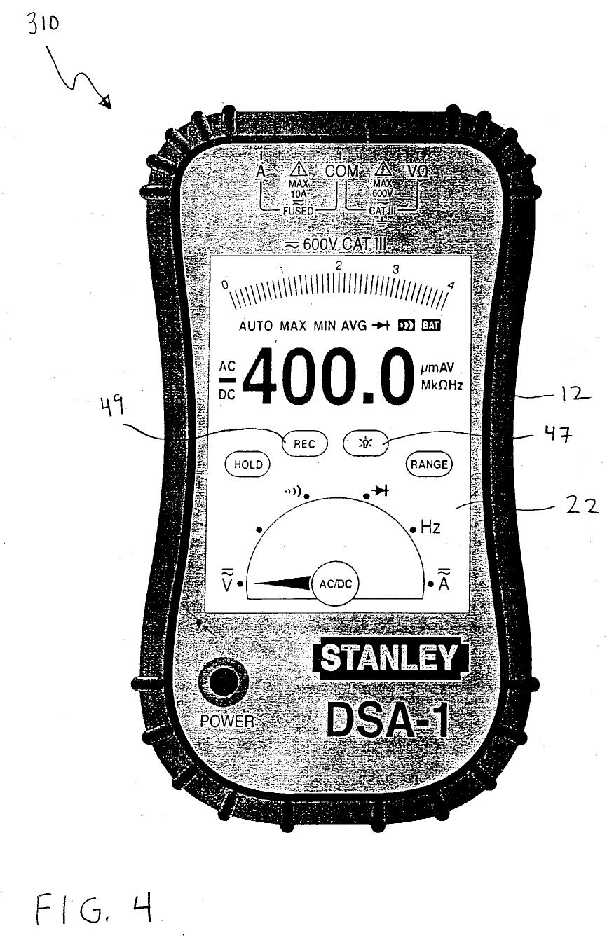

Another embodiment of the handheld multimeter, indicated as 310 is shown in FIG. 4. The components of the handheld multimeter 310 are substantially similar to the components of the handheld multimeter 10 and thus will not be further detailed herein. In contrast to the multimeter 10, the multimeter 310 does not include an up-arrow button, a down-arrow button, an activation button, or a speaker/buzzer. Further, the multimeter 310 illustrates another embodiment of the configuration of the elements displayed on the display screen 22. For example, the display 22 of the multimeter 310 includes a backlight key 47 for operating the backlight feature and a record key 49 (i.e., REC) for recording minimum and maximum readings, for example.

The handheld multimeter 10, 210, 310 is advantageous in that it offers greatly reduced size for improved portability versus traditional multimeters. Moreover, the handheld multimeter 10, 210, 310 offers increased computing power for multiple applications choices versus traditional multimeters. However, the handheld multimeter 10, 210, 310 may be configured such it is operable to perform a multimeter function only without any typical PDA functions.

It can thus be appreciated that the objectives of the present invention have been fully and effectively accomplished. The foregoing specific embodiments been provided to illustrate the structural and functional principles of the present invention and is not intended to be limiting. To the contrary, the present invention is intended to encompass all modifications, alterations, and substitutions within the spirit and scope of the appended claims.

What is claimed is:

1. A handheld multimeter comprising:
an outer shell configured to be received in a user's hand;
a computer processor housed within the outer shell for processing data;
a pressure-sensitive display screen facing outwardly from a front side of the outer shell, the pressure-sensitive display screen being electrically coupled to the computer processor to enable the processor to display simulated input elements on the screen and enable the user to input data commands into the computer processor by contacting the pressure-sensitive display screen;
a data port coupled to the computer processor; and
a conductive probe assembly structured to generate electrical data, the probe assembly being electrically coupled to the data port to enable communication of the electrical data between the probe assembly and the computer processor,
wherein the computer processor is configured to process the electrical data received from the probe assembly and display an output value on the display screen that includes at least one of an electrical voltage value, an electrical resistance value, and an electrical current value.

2. The handheld multimeter according to claim 1, wherein the input elements include a plurality of keys corresponding to at least one of a range key, a hold key, and an electrical parameter indicator key.

3. The handheld multimeter according to claim 1, wherein the data port includes two input jacks that are structured to be electrically coupled with input ends of the probe assembly.

4. The handheld multimeter according to claim 1, further comprising a memory electrically coupled to the processor for storing executable programs and data.

5. The handheld multimeter according to claim 4, wherein the memory includes a multimeter software program that has a series of computer executable instructions that are executable by the processor to interpret the electrical data generated by the probe assembly and convert the electrical data into instructions which are recognizable and executable by the processor.

6. The handheld multimeter according to claim 1, wherein the input elements include a plurality of keys corresponding to at least one of a scheduler, an address book, and a notepad.

7. The handheld multimeter according to claim 1, wherein the computer processor is configured to perform the functions of at least one of a scheduler, an address book, and a notepad and enables the pressure sensitive display screen to receive input information for the relevant function.

8. A handheld multimeter comprising:
an outer shell configured to be received in a user's hand;
a computer processor housed within the outer shell for processing data;
a pressure-sensitive display screen facing outwardly from a front side of the outer shell, the pressure-sensitive display screen being electrically coupled to the computer processor to enable the processor to display simulated input elements on the screen and enable the user to input data commands into the computer processor by contacting the pressure-sensitive display screen; and
a conductive probe assembly housed within the outer shell and structured to generate electrical data, the probe assembly being electrically coupled to the computer processor to enable communication of the electrical data between the probe assembly and the computer processor,
wherein the computer processor is configured to process the electrical data received from the probe assembly and display an output value on the display screen that includes at least one of an electrical voltage value, an electrical resistance value, and an electrical current value.

9. The handheld multimeter according to claim 8, wherein the input elements include a plurality of keys corresponding to at least one of a range key, a hold key, and an electrical parameter indicator key.

10. The handheld multimeter according to claim 8, further comprising a memory electrically coupled to the processor for storing executable programs and data.

11. The handheld multimeter according to claim 10, wherein the memory includes a multimeter software program that has a series of computer executable instructions that are executable by the processor to interpret the electrical data generated by the probe assembly and convert the electrical data into instructions which are recognizable and executable by the processor.

12. The handheld multimeter according to claim 8, wherein the input elements include a plurality of keys corresponding to at least one of a scheduler, an address book, and a notepad.

13. The handheld multimeter according to claim 8, wherein the computer processor is configured to perform the functions of at least one of a scheduler, an address book, and a notepad and enables the pressure sensitive display screen to receive input information for the relevant function.

14. A handheld multimeter comprising:
an outer shell configured to be received in a user's hand;
a computer processor housed within the outer shell for processing data;
a pressure-sensitive display screen facing outwardly from a front side of the outer shell, the pressure-sensitive display screen being electrically coupled to the computer processor to enable the processor to display simulated input elements on the screen and enable the user to input data commands into the computer processor by contacting the pressure-sensitive display screen;
a data port coupled to the computer processor; and
a conductive probe assembly structured to generate electrical data, the probe assembly being electrically coupled to the data port to enable communication of the electrical data between the probe assembly and the computer processor,
wherein the computer processor is configured to (a) process the electrical data received from the probe assembly and display an output value on the display screen that includes at least one of an electrical voltage value, an electrical resistance value, and an electrical current value, and (b) perform the functions of at least one of a scheduler, an address book, and a notepad.

15. The handheld multimeter according to claim 14, wherein the input elements include a plurality of keys corresponding to at least one of a range key, a hold key, and an electrical parameter indicator key.

16. The handheld multimeter according to claim 14, wherein the data port includes two input jacks that are structured to be electrically coupled with input ends of the probe assembly.

17. The handheld multimeter according to claim 14, further comprising a memory electrically coupled to the processor for storing executable programs and data.

18. The handheld multimeter according to claim 17, wherein the memory includes a multimeter software program that has a series of computer executable instructions that are executable by the processor to interpret the electrical data generated by the probe assembly and convert the electrical data into instructions which are recognizable and executable by the processor.

19. The handheld multimeter according to claim 14, wherein the input elements include a plurality of keys corresponding to at least one of a scheduler, an address book, and a notepad.

20. The handheld multimeter according to claim 14, wherein the computer processor is configured to perform the functions of at least one of a scheduler, an address book, and a notepad and enables the pressure sensitive display screen to receive input information for the relevant function.
